(19) United States
(12) Patent Application Publication
(10) Pub. No.: US 2010/0103172 A1
(43) Pub. Date: Apr. 29, 2010

(54) SYSTEM AND METHOD FOR RENDERING AMBIENT LIGHT AFFECTED APPEARING IMAGERY BASED ON SENSED AMBIENT LIGHTING

(75) Inventor: Gregor N. Purdy, SR., Sunnyvale, CA (US)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/260,048

(22) Filed: Oct. 28, 2008

(51) Int. Cl. G06T 15/60

(52) U.S. Cl. 345/426

(57) ABSTRACT

A method for rendering ambient light affected appearing imagery on a two-dimensional display screen in dependence on sensed ambient lighting conditions about the display screen is disclosed. The method includes processing, on a microprocessor in control communication with the display screen, data defining sensed ambient lighting conditions about the display screen, and based on said data, determining at least one light source's location relative to the display screen and an intensity of light from that at least one light source at the display screen. The method then includes rendering an image of a constructed scene on the display screen based on the determined location of the at least one light source relative to the display screen and the intensity of light from that at least one light source at the display screen and thereby presenting an ambient light affected image of the constructed scene on the display screen.

### FIELD

This disclosure relates to rendering imagery, and more particularly to a system and method for rendering imagery that appears lighting affected based on sensed ambient lighting.

### BACKGROUND

Consumers have access to a wide variety of electronic devices that have displays such as notebook computers, desktop computers, flat-screen televisions, cell phones and smart phones, among others. These electronic devices may contain an integrated display, such as is the case with many cell phones. Also, many devices such as some desktop and notebook computers are connected to a display such as an external monitor that is connected to the CPU of the computer, but not integrally constructed therewith. Some devices of this nature can contain an embedded light sensor capable of sensing ambient light conditions. The information is typically used to make brightness adjustments to the display based on the sensed ambient light level. For example, a device may automatically increase the brightness level of an associated display screen in a strong, bright ambient light environment. Similarly, the same device may automatically lower the brightness level of the display screen when a dim ambient light environment is detected. Adjusting the brightness of a display screen in this manner based on ambient light intensity is intended to result in a better viewing experience for the user, and it can as well provide power saving benefits, for instance when the power to the display is decreased during dimming.

This disclosure appreciates the fact that imagery is typically presented on display screens of all types, including those types described above. In order to make the images more engaging, it has also been appreciated that if more specific sensed ambient lighting conditions (direction, intensity, color and the like) could be applied to the imagery, those images would be more realistic in appearance, and therefore more natural and pleasing to the viewer. Among other enhancements, characteristics of the imagery could be altered in view of actual ambient lighting conditions around the device. For example, the shading or brightness of the imagery could be made to correspond to the ambient light characteristics around the display screen.

As an example, if a user is looking at a display of a notebook computer positioned on a desk and a lamp is positioned to the right of the notebook (see FIG. 6A as an illustrative example), it would be much more realistic if imagery on the display such as icons, windows and other graphical user interface elements were adapted to appear as though that shining lamp was affecting their appearance. In this context, the icons, windows and other graphical user interface elements would appear as though the light from the lamp on the desk was actually also shining on them. This can be accomplished by, among other things, altering the shading of the images to add shadow effects away from the light source and to add brightness effects toward the light source. Therefore, the present disclosure capitalizes on these lighting-induced naturally occurring effects that users have come to expect in the real world by adjusting the presentation of displayed images in dependence on the sensed ambient lighting conditions about the display screen. Among others, the sensed lighting characteristics can include direction, magnitude and color from multiple light sources that would affect the appearance of objects located where the display screen is positioned.

### SUMMARY

Additional features and advantages of the present disclosure will be set forth in the description which follows, and in part will be obvious from the description, or may be learned through the practice of what is taught. Further, the features and advantages of the disclosure may be realized and obtained by means of the instruments and combinations particularly pointed out in the patented claims. These and other features will become more fully apparent from the following description and the patented claims, or may be learned by the practice of that which is described.

This disclosure describes a system and method for rendering ambient light affected imagery on a display screen based on sensed ambient lighting conditions. Systems, methods and computer readable media are disclosed for rendering such ambient light affected imagery based on sensed lighting conditions around the display. In a most basic sense, the present system presents images on a display screen in a way that mimics how ambient light would affect the appearance of the represented articles in the images if actually present. Using the example above of viewing a notebook display screen positioned on a desk with a lamp on the desk to the right of the notebook, the presently disclosed system and method presents images on the screen that correspond more realistically to what would be seen if the ambient lighting about the display were also affecting the articles being shown on the screen. Among other things, the direction of incidence, color, and strength of light emitting from one or more light sources near the display screen can be sensed and assessed, and then the images presented on the display screen can be correspondingly adapted to mimic the existing lighting effects.

Similar to the computer/lamp example above where one light source is considered, the present disclosure also contemplates sensing and assessing lighting information about multiple light sources that each bear on the display screen. For example, the lamp to the right of the computer will affect the display screen. Furthermore, an overhead incandescent light could also affect the display screen. Additionally, the user can have a candle burning to the left of the notebook screen. The sensors in this example would collect information (detect lighting conditions) and output data representative thereof which when processed, allows the system to determine the direction of incidence and brightness of light at the respective sensor, and based thereupon, present images on the display in correspondence therewith. In this manner even the flickering effect from the candle can be reflected in the presentation of the imagery on the display screen. Similarly, if one of the light sources is turned off, such as the lamp to the right of the notebook in this example, the resulting effect can be simultaneously reflected in the presentation of the imagery on the display.

Aspects of the method disclosed herein and the principles associated therewith are also applicable to the system and computer readable medium embodiments that are also described. Accordingly, a method for rendering ambient light affected appearing imagery on a two-dimensional display screen in dependence on sensed ambient lighting conditions about the display screen is disclosed. The method includes processing, on a microprocessor in control communication with the display screen, data defining sensed ambient lighting conditions about the display screen, and based on that data, determining at least one light source's location relative to the display screen and an intensity of lighting from that light source at the display screen. The method then includes rendering an image of a constructed scene on the display screen based on the determined location of the one or more light source(s) relative to the display screen (which can be assessed based on the angle of incidence of light detected at the sensor) and the intensity of light from the source(s) at the display screen in order to present an ambient light affected image of the constructed scene on the display screen.

Exemplarily, the method can include adding shadow effects to the constructed scene based on the determined location of the light source(s) relative to the display screen and the intensity of light from the light source(s) at the display screen.

The method can also include adding highlight or brightness effects to the constructed scene based on the determined location of the light source(s) relative to the display screen and the intensity of light from the light source(s) at the display screen.

The method can also include adding both shadow effects and highlight effects to the constructed scene based on the determined location of the light source(s) relative to the display screen and the intensity of light from the light source(s) at the display screen.

As described, the method can include determining, for a plurality of light sources, each light source's location relative to the display screen and an intensity of lighting from the source at the display screen and rendering the image of a constructed scene on the display screen based on the determined locations of the plurality of light sources relative to the display screen and the intensity of light from each of the light sources at the display screen.

The method can include utilizing one or more detectors to sense the ambient lighting conditions about the display screen and output data defining sensed ambient lighting conditions about the display screen.

In this embodiment, the one or more detectors can be utilized to sense a lighting-induced ambient color hue about the display screen and output data defining the sensed ambient color hue about the display screen. In this regard, the method can responsively include adding a color cast to the constructed scene based on the sensed lighting-induced ambient color hue detected about the display screen. For instance, if a red hue is detected, possibly from a red-colored light, a similar red color can be cast on the imagery displayed on the screen for uniformity with the surroundings.

The detector can utilize, for example, light sensing semiconductor devices such as a photocell, photodiode, phototransistor, charge coupled device (CCD) or complementary metal oxide semiconductor (CMOS). Additionally, the detector can utilize a vacuum tube device such as photo-electric tube or photomultiplier tube to detect the lighting characteristics. However, the system and method applies to all display screens, including those incorporated on portable computing devices or combination of devices that allow rendering ambient light affected appearing imagery on a two-dimensional display screen in dependence on sensed ambient lighting conditions about the display screen.

### BRIEF DESCRIPTION OF THE DRAWINGS

In order to describe the manner in which the advantages and features of this disclosure can be obtained, a more particular description is provided below, including references to specific embodiments which are illustrated in the appended drawings. Understanding that these drawings depict only exemplary embodiments and are not therefore to be considered limiting, the subject matter will be described and explained with additional specificity and detail through the use of the accompanying drawings in which:

FIG. 1 illustrates an example system embodiment;

FIG. 2 illustrates an example ambient light affected appearing image;

FIG. 3 illustrates an example device embodiment;

FIG. 4 illustrates another example ambient light affected appearing image;

FIG. 5 is a flowchart illustrating an example method embodiment;

FIG. 6A illustrates a device displaying ambient light affected appearing imagery in a scene; and

FIG. 6B illustrates a virtual scene corresponding to the imagery of FIG. 6A.

### DETAILED DESCRIPTION

Various example embodiments of the rendering of more realistic appearing imagery or scenes on display screens are described in detail below. While specific implementations are discussed, it should be understood that this is done for illustration purposes only. A person skilled in the relevant art will recognize that other components and configurations may be used without departing from the spirit and scope of the disclosure.

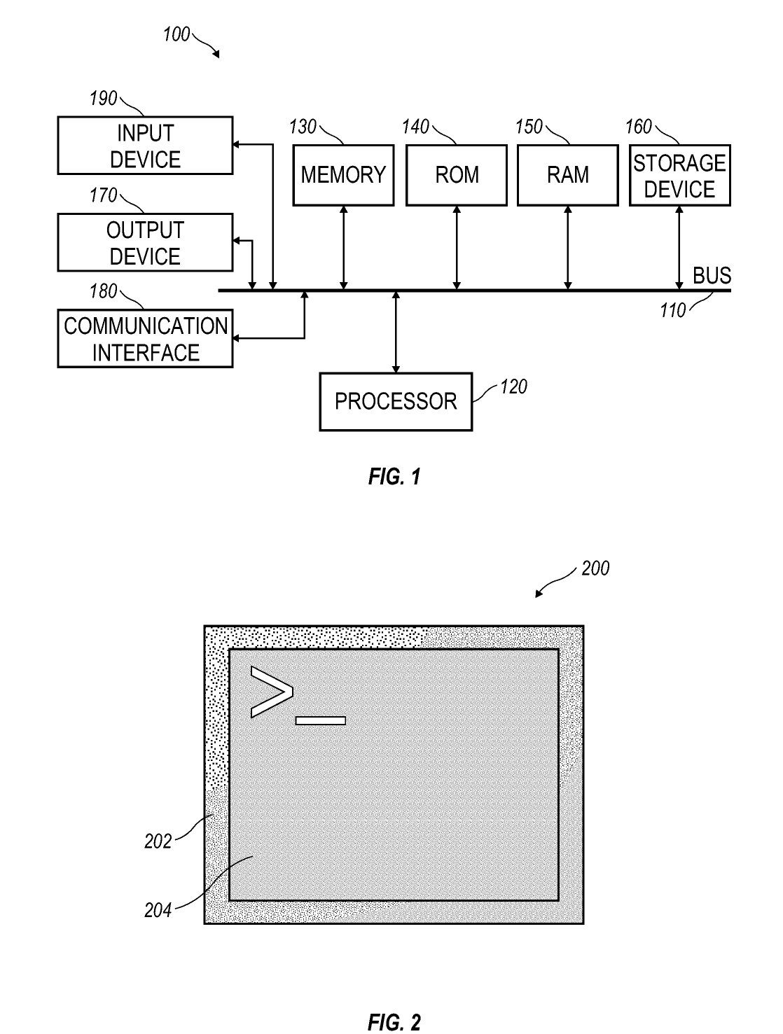

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the program may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up.

The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction requiring operation on any particular hardware arrangement and therefore the basic features here may easily be substituted for improved hardware or firmware arrangements as they are developed.

For clarity of explanation, the illustrative system embodiment is presented as comprising (including, but not limited to) individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Many modern systems have “GPU” (Graphics Processing Unit) components that, together with software, are used to do accelerated 3D scene rendering as is the typical case for games. This same technology is commonly used in modern graphical environments, such as OS X, from Apple Inc., to provide the rendering of the display for applications and visual effects of the environment and within applications.

As noted above, the present disclosure enables the rendering of imagery in consideration of sensed ambient lighting conditions. Any computing device (unitary or multi-component based) with a display screen capable of rendering such adapted imagery based on sensed ambient lighting is contemplated as within the scope and spirit of this disclosure. For example, stand alone display screens such as flat screen television monitors are contemplated to fit within the claimed scope as such monitors have either integrated processors or connected processors capable of fulfilling the data processing requirements of the disclosure. Similarly, user interface screens on handheld devices are also contemplated because the requirement of a display screen and controlling processor are satisfied. Similarly, any type of electronic light sensor is contemplated as within the scope of this disclosure provided it has the claimed capabilities.

FIG. 2 illustrates an example ambient light affected appearing image 200. The image 200 includes a frame 202 and display portion 204. This image 200 represents an icon for an application program, and the program will be opened upon a user selecting the icon with a cursor, for example. The image 200 looks brightest, i.e. has less shading, on the upper left hand corner of the image 200. This gives the illusion that a light source is positioned proximate to and aimed towards the upper left hand corner of the icon. As described, the characteristics of the ambient light affected image 200 can be adjusted based on sensed ambient light. For example, if a flashlight is pointed towards the bottom right hand corner of the image 200, the characteristics of the image will be adjusted to make the bottom right hand corner of the image the brightest portion of the image, with the top left hand corner of the image the darkest part of the image. This process gives the illusion that the ambient light is causing the ambient light affected appearing imagery on the display screen.

This image 200 can be stored as a three-dimensional model. Alternatively, the image can be stored as a two-dimensional model which the computer modifies to a three-dimensional model upon display. Other methods of storing and displaying three-dimensional appearing imagery are within the scope of this disclosure.

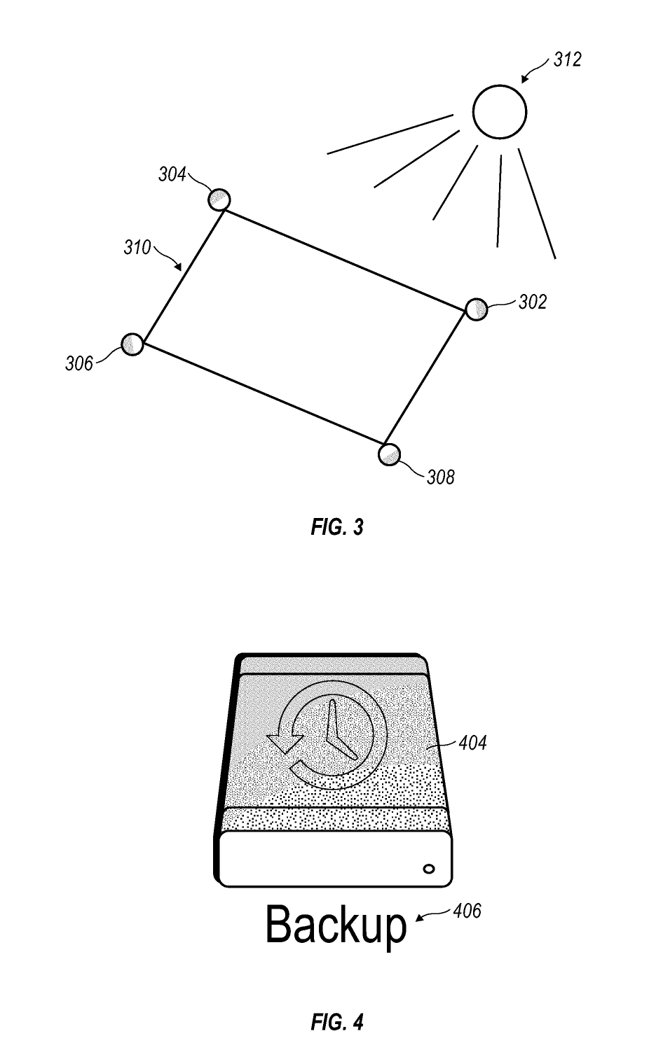

FIG. 3 illustrates an example device embodiment of the disclosure. A display 310 is shown. The display 310 can be incorporated into an electronic device such as a phone, PDA, personal entertainment device, notebook computer, or desktop computer. The display 310 can be a LCD (liquid crystal display). A first light sensor 302, a second light sensor 304, a third light sensor 306, and a fourth light sensor 308 are positioned around the display screen 310. Each light sensor can be a CCD (charge coupled device) which is sensitive to visible light. Other light sensing technologies, such as CMOS (complementary metal oxide semiconductor), can be used as well. A light source 312 is also shown.

In the illustration of FIG. 3, the first light sensor 302, the second light sensor 304, the third light sensor 306, and the fourth light sensor 308 are exemplarily located in fixed positions relative to the display 310. The first light sensor 302, the second light sensor 304, the third light sensor 306, and the fourth light sensor 308 are positioned to capture ambient light shining on the display 310 and to measure either directly or indirectly at least the angle(s) of incidence and the intensity of light on the display, and optionally, any light-induced color imposed on the display.

In this example, the light sensors are essentially identical but located at different corners of the generally square display 310. Thus, a light source directly above the middle of the display 310 would cause equal sensor values at each of the sensors. But, as the light source 312 is moved away from this central middle position, lighting will become more intense on some sensors and less intense on others. In this example, if all sensors have at least a value X, then the value X can be attributed to the global ambient light illumination from the environment. Then, the remaining values of the sensors above value X can be used to determine a direction of incidence and intensity of light from the source(s) of interest. More complex computational analysis, which may involve vector analysis, can be implemented to achieve more precise sensing and analysis of such light sources.

Each light sensor can be, for example, a light sensing semiconductor device such as a photocell, photodiode, phototransistor, charge coupled device (CCD) or complementary metal oxide semiconductor (CMOS). Additionally, each sensor can utilize one or more vacuum tube device such as a photo-electric tube and a photomultiplier tube to detect light. A mix of combinations of various types of light sensors can be used.

FIG. 4 illustrates another example ambient light affected appearing image 404. In this example the image 404 represents an external backup drive for data storage. The image 404 includes associated name metadata 406 that in this example indicates the “Backup” name for the drive. The image looks brightest, i.e. has less shading, on the lower right hand corner of the front face of the image. This gives the illusion that a fixed light source is positioned closest to and aimed towards the lower right hand corner of the front face of the drive image 404. As described above, the characteristics of the ambient light affected image can be adjusted based on sensed ambient light. For example, if a flashlight is pointed towards the left side of the image, the characteristics of the image, such as shading and brightness, will be adjusted to correspond to the sensed ambient lighting. This process gives the illusion that ambient lighting is affecting/causing the ambient light affected appearing imagery on the display screen.

Similar to FIG. 2, this image 404 can be stored as a three-dimensional model. Alternatively, the image 404 can be stored as a two-dimensional model which the computer modifies to a three-dimensional model upon display. Other methods of storing and displaying ambient light affected three-dimensional appearing imagery are within the scope of this disclosure.

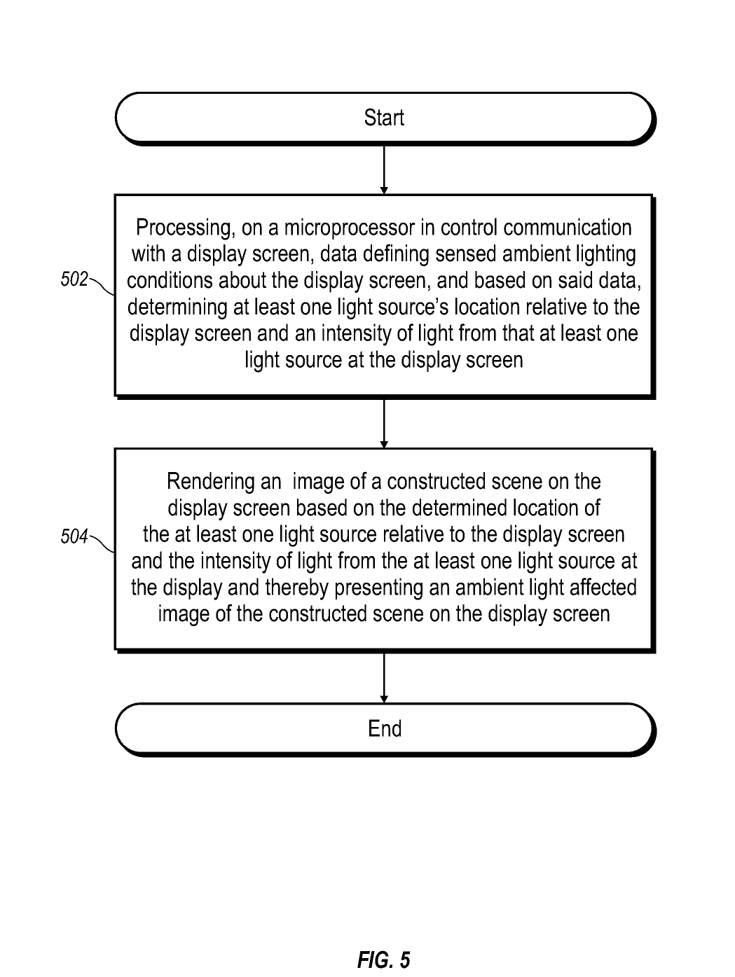

The present disclosure now turns to an exemplary method embodiment that is described. FIG. 5 charts an example of the method.

Accordingly, a method for rendering ambient light affected appearing imagery on a two-dimensional display screen in dependence on sensed ambient lighting conditions about the display screen is disclosed. The method includes processing 502, on a microprocessor in control communication with the display screen, data defining sensed ambient lighting conditions about the display screen, and based on said data, determining at least one light source's location relative to the display screen and an intensity of light from that at least one light source at the display screen. The method then includes rendering 504 an image of a constructed scene on the display screen based on the determined location of the at least one light source relative to the display screen and the intensity of light from that at least one light source at the display screen and thereby presenting an ambient light affected image of the constructed scene on the display screen.

The ambient light affected appearing imagery can include any images in a graphical user interface such as application icons, windows, input interface elements, wallpaper images, and any other images capable of being displayed.

The method can include adding shadow effects to the constructed scene based on the determined location of the at least one light source relative to the display screen and the intensity of light from that at least one light source at the display screen.

The method can also include adding highlight effects to the constructed scene based on the determined location of the at least one light source relative to the display screen and the intensity of light from that at least one light source at the display screen.

The method can also include adding shadow effects and highlight effects to the constructed scene based on the determined location of the at least one light source relative to the display screen and the intensity of light from that at least one light source at the display screen.

Furthermore, the method can include determining, for a plurality of light sources, each light source's location relative to the display screen and an intensity of light from the source at the display screen and rendering the image of a constructed scene on the display screen based on the determined locations of the plurality of light sources relative to the display screen and the intensity of light from each of the light sources at the display screen.

The method can include utilizing a plurality of detectors to sense the ambient lighting conditions about the display screen and output data defining sensed ambient lighting conditions about the display screen.

The method can also include utilizing at least one detector to sense the ambient lighting conditions about the display screen and output data defining sensed ambient lighting conditions about the display screen. In this example, the at least one detector can be utilized to sense a lighting-induced ambient color hue about the display screen and output data defining the sensed ambient color hue about the display screen. Furthermore, in this example, the method can include adding a color cast to the constructed scene based on the sensed lighting-induced ambient color hue about the display screen. For example, if red light is directed toward the screen, a red color will be cast on the constructed scene based on the sensed lighting-induced red ambient color hue occurring about the display screen.

Sometimes an application may call for, or a user may desire, a selective de-activation of the ambient light affected appearing imagery. In such a circumstance, portions of the display screen, or alternatively windows of selected programs will not present an ambient light affected image in the areas selectively de-activated. The other portions of the screen and applications and graphical user interface elements can, however, operate according to the systems and methods described herein.

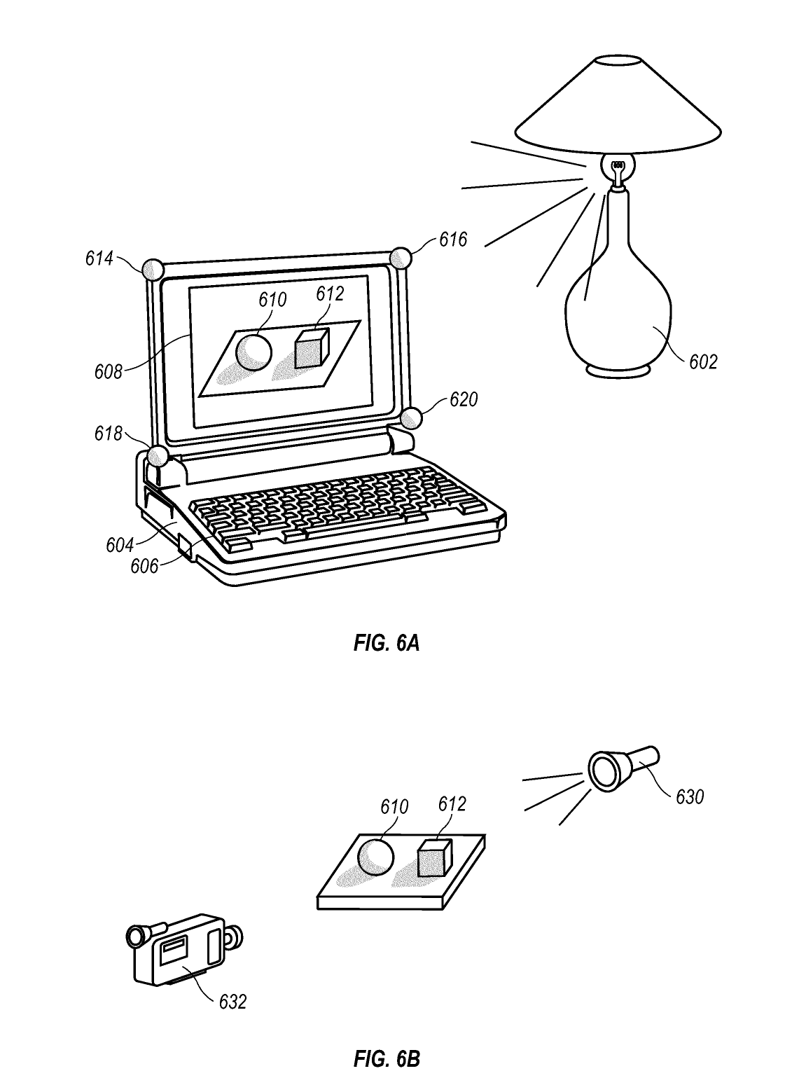

FIG. 6A illustrates a device displaying ambient light affected appearing imagery in a scene. A notebook computer 604 is shown. A lamp 602 projects ambient light towards the notebook computer 604. The notebook computer includes a keyboard 606 and a display screen 608. The notebook computer 604 also features a first light sensor 614, a second light sensor 616, a third light sensor 618, and a fourth light sensor 620. The light sensors sense ambient light generated by lamp 602. On display screen 608, a generated scene is shown. The scene includes three-dimensional objects. Specifically, the three-dimensional objects include a sphere 610 and a cube 612. In this embodiment, the three-dimensional objects sphere 610 and cube 612 are stored and displayed in the scene as three-dimensional models. The first light sensor 614, the second light sensor 616, the third light sensor 618, and the fourth light sensor 620 detect ambient light, including that from the lamp 602, and the computer displays an ambient light affected image of the constructed scene on the display screen 608.

FIG. 6B illustrates a virtual scene corresponding to the imagery of FIG. 6A. The virtual scene includes sphere object 610 and cube object 612. A virtual light source 630 is directed toward the scene to correspond to sensed ambient lighting characteristics. Although one virtual light source 630 is shown, more than one virtual light source may be directed on the scene by the system to correspond to multiple detected ambient light sources affecting the display of the notebook computer. Highlights and shading characteristics are applied to the scene, specifically to sphere object 610 and cube object 612 as shown. A virtual camera 632 is placed to view the ambient light affected scene. The virtual camera 632 determines which view of the scene will be presented on the display of the notebook computer, and hence to the viewer of the device. The view of the scene captured by virtual camera 632 corresponds to the rendered scene shown on the display of the notebook 604 of FIG. 6A.

Embodiments within the scope of the present disclosure may also include computer-readable media for carrying or having computer-executable instructions or data structures configured according to this description stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. A “tangible” computer-readable medium expressly excludes software per se (not stored on a tangible medium) and a wireless, air interface. Thus, any such connection is properly termed a computer-readable medium. Combinations of the above are also considered to be included within the scope of the recited computer-readable media.

Computer-executable instructions include, for example, instructions and data that cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

Those of skill in the art will appreciate that other embodiments of this disclosure may be practiced in network computing environments with many types of computer system configurations, including personal computers, hand-held devices, multi-processor systems, microprocessor-based or programmable consumer electronics, network PCs, minicomputers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments are part of the scope of this disclosure. Accordingly, the patented claims and their legal equivalents shall only define the invention(s), rather than any specific examples described herein.

I claim:

1. A method for rendering ambient light affected appearing imagery on a two-dimensional display screen in dependence on sensed ambient lighting conditions about the display screen, said method comprising:
processing, on a microprocessor in control communication with the display screen, data defining sensed ambient lighting conditions about the display screen, and based on said data, determining at least one light source's location relative to the display screen and an intensity of light from that at least one light source at the display screen; and
rendering an image of a constructed scene on the display screen based on the determined location of the at least one light source relative to the display screen and the intensity of light from that at least one light source at the display screen and thereby presenting an ambient light affected image of the constructed scene on the display screen.

2. The method as recited in claim 1, wherein the step of rendering the image comprises adding shadow effects to the constructed scene based on the determined location of the at least one light source relative to the display screen and the intensity of light from that at least one light source at the display screen.

3. The method as recited in claim 1, wherein the step of rendering the image comprises adding highlight effects to the constructed scene based on the determined location of the at least one light source relative to the display screen and the intensity of light from that at least one light source at the display screen.

4. The method as recited in claim 1, wherein the step of rendering the image comprises adding shadow effects and highlight effects to the constructed scene based on the determined location of the at least one light source relative to the display screen and the intensity of light from that at least one light source at the display screen.

5. The method as recited in claim 1, further comprising:
determining, for a plurality of light sources, each light source's location relative to the display screen and an intensity of light from the source at the display screen; and
rendering the image of a constructed scene on the display screen based on the determined locations of the plurality of light sources relative to the display screen and the intensity of light from each of the light sources at the display screen.

6. The method as recited in claim 1, further comprising:
utilizing a plurality of detectors to sense the ambient lighting conditions about the display screen and output data defining sensed ambient lighting conditions about the display screen.

7. The method as recited in claim 1, further comprising:
utilizing at least one detector to sense the ambient lighting conditions about the display screen and output data defining sensed ambient lighting conditions about the display screen.

8. The method as recited in claim 7, wherein the at least one detector is utilized to sense a lighting-induced ambient color hue about the display screen and output data defining the sensed ambient color hue about the display screen.

9. The method as recited in claim 8, wherein the step of rendering the image comprises adding a color cast to the constructed scene based on the sensed lighting-induced ambient color hue about the display screen.

10. A system for rendering ambient light affected imagery on a two-dimensional display screen in dependence on sensed ambient lighting conditions about the display screen, said system comprising:
a microprocessor to process in control communication with the display screen, data defining sensed ambient lighting conditions about the display screen, and based on said data, determining at least one light source's location relative to the display screen and an intensity of light from that at least one light source at the display screen; and
a module to render an image of a constructed scene on the display screen based on the determined location of the at least one light source relative to the display screen and the intensity of light from that at least one light source at the display screen and thereby presenting an ambient light affected image of the constructed scene on the display screen.

11. The system as recited in claim 10, further comprising a module to add shadow effects to the constructed scene based on the determined location of the at least one light source relative to the display screen and the intensity of light from that at least one light source at the display screen.

12. The system as recited in claim 10, further comprising a module to add highlight effects to the constructed scene based on the determined location of the at least one light source relative to the display screen and the intensity of light from that at least one light source at the display screen.

13. The system as recited in claim 10, further comprising a module to add shadow effects and highlight effects to the constructed scene based on the determined location of the at least one light source relative to the display screen and the intensity of light from that at least one light source at the display screen.

14. The system as recited in claim 10, further comprising:
a module to determine, for a plurality of light sources, each light source's location relative to the display screen and an intensity of light from the source at the display screen; and
a module to render the image of a constructed scene on the display screen based on the determined locations of the plurality of light sources relative to the display screen and the intensity of light from each of the light sources at the display screen.

15. The system as recited in claim 10, further comprising
a plurality of detectors to sense the ambient lighting conditions about the display screen and output data defining sensed ambient lighting conditions about the display screen.

16. The system as recited in claim 10, further comprising:
at least one detector to sense the ambient lighting conditions about the display screen and output data defining sensed ambient lighting conditions about the display screen.

17. The system as recited in claim 16, wherein the at least one detector is utilized to sense a lighting-induced ambient color hue about the display screen and output data defining the sensed ambient color hue about the display screen.

18. The system as recited in claim 17, further comprising a module to add a color cast to the constructed scene based on the sensed lighting-induced ambient color hue about the display screen.

19. A tangible computer-readable medium storing instructions for rendering ambient light affected appearing imagery, the instructions comprising:
processing, on a microprocessor in control communication with the display screen, data defining sensed ambient lighting conditions about the display screen, and based on said data, determining at least one light source's location relative to the display screen and an intensity of light from that at least one light source at the display screen; and
rendering an image of a constructed scene on the display screen based on the determined location of the at least one light source relative to the display screen and the intensity of light from that at least one light source at the display screen and thereby presenting an ambient light affected image of the constructed scene on the display screen.
